(19) United States
(12) Patent Application Publication
(10) Pub. No.: US 2006/0068359 A1
(43) Pub. Date: Mar. 30, 2006

(54) DENTAL TOOL

(76) Inventor: Hunter L. Reap, Durham, NC (US)

Correspondence Address: MOORE & VAN ALLEN PLLC, P.O. BOX 13706, Research Triangle Park, NC, 27709, US

(21) Appl. No.: 10/711,694

(22) Filed: Sep. 30, 2004

(51) Int. Cl. A61C 19/04

(52) U.S. Cl. 433/72

(57) ABSTRACT

A dental tool is used in determining an amount of material removed from a face of a tooth between two immediately adjacent teeth. The dental tool comprises a base member having a substantially planar surface and a projection extending from the planar surface a distance adapted to be equal to the amount of tooth material to be removed from the face of the tooth. The projection is adapted to be positioned adjacent any portion of the face of the tooth and the planar surface is sized such that the planar surface is over the two immediately adjacent teeth on either side of the tooth at all relative positions of the projection and the tooth.

### BACKGROUND

The present invention relates to a dental tool, and more particularly to a dental tool for use in preparing a tooth for a fixed restoration.

A fixed restoration is any of a variety of replacements for a missing tooth, or a part of a tooth, which are permanently affixed in the mouth. Fixed restorations may include, for example, artificial crowns and fixed partial dentures.

A fixed restoration procedure for a tooth requires the re-sizing of the tooth, which involves a dentist using a burr to remove a portion of the face of a tooth. After some of the tooth has been removed, the dentist will typically observe the tooth to determine if further removal of tooth material is required. The dentist repeats the process of tooth material removal and observation until satisfied. Unfortunately, the results may prove to be inaccurate, which could require subsequent re-sizing of the tooth, or possibly even compromise the outcome of the restoration. As a result, the current process for tooth re-sizing is inefficient, sometimes inaccurate, and time consuming.

For the foregoing reasons there is a need for a dental tool for use in tooth re-sizing. The new dental tool should provide an efficient, easy to use means for determining whether a tooth is accurately prepared for a fixed restoration.

### SUMMARY

According to the present invention, a dental tool is provided for use in determining an amount of material removed from a face of a tooth between two immediately adjacent teeth. The dental tool comprises a base member having a substantially planar surface and a projection extending from the planar surface a distance adapted to be equal to the amount of tooth material to be removed from the face of the tooth. The projection is adapted to be positioned adjacent any portion of the face of the tooth and the planar surface is sized such that the planar surface is over the two immediately adjacent teeth on either side of the tooth at all relative positions of the projection and the tooth.

Also according to the present invention, a method is provided for determining an amount of material removed from a face of a tooth between two immediately adjacent teeth. The method comprises the steps of providing a dental tool comprising a base member having a substantially planar surface, and a projection extending from the planar surface a distance adapted to be equal to the amount of tooth material to be removed from the face of the tooth. The dental tool is placed against the tooth so that the projection is adjacent the face of the tooth and the planar surface is over the two immediately adjacent teeth. The dental tool is then moved relative to the teeth so that the projection engages all portions of the surface of the tooth to be removed and the planar surface is over the two immediately adjacent teeth at all relative positions of the projection and the tooth.

### DRAWINGS

For a more complete understanding of the present invention, reference should now be had to the embodiments shown in the accompanying drawings and described below.

FIG. 1 is a perspective view of an embodiment of a dental tool according to the present invention;

FIG. 2 is a top plan view of the dental tool as shown in FIG. 1;

FIG. 3 is a perspective view of the dental tool as shown in FIG. 1 in use in a human mouth;

FIG. 4 is a top cross-sectional view taken along line 4-4 of FIG. 3;

FIG. 5 is a perspective view of another embodiment of a dental tool according to the present invention; and

FIG. 6 is an exploded perspective view of yet another embodiment of a dental tool according to the present invention.

### DESCRIPTION

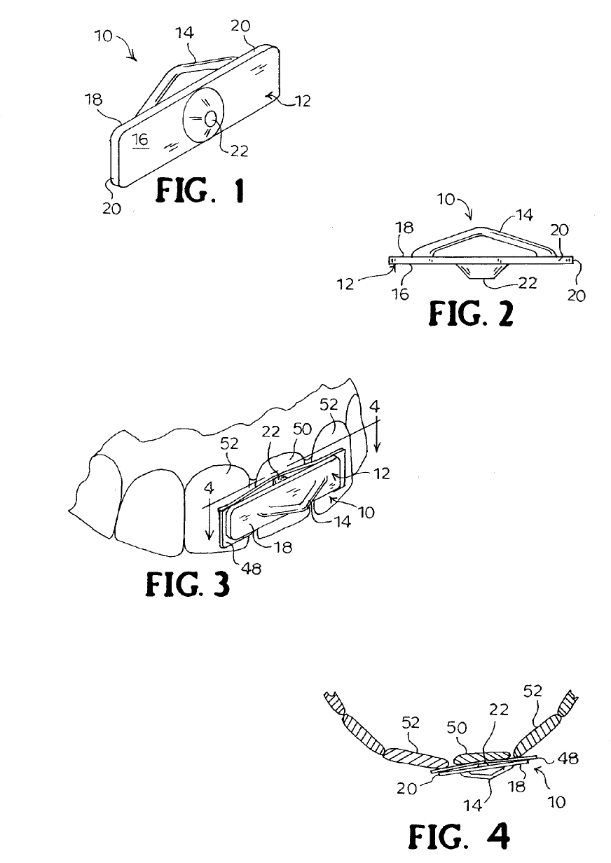

Referring now to the drawings, wherein like reference numerals designate corresponding or similar elements throughout the several views, an embodiment of a dental tool 10 according to the present invention is shown in FIGS. 1 and 2 and generally designated at reference numeral 10. The dental tool 10 comprises a base portion 12 and a handle portion 14.

The base portion 12 has a rectangular shape with a substantially planar front major surface 16 and a rear major surface 18. Thin edge surfaces 20 extend between and interconnect the front surface 16 and the rear surface 18. Although the base portion 12 is shown as rectangular in shape, it is understood that the base portion 12 may be of any shape provided that at least a portion of the front surfacer 6 of the base portion 12 is substantially planar.

A projection 22 extends from the front surface 16 of the base portion 12. The projection 22 is conveniently hemispherical in shape, although it is understood that the projection 22 may be any shape.

The handle portion 14 extends from the rear surface 18 of the base portion 12. In the embodiment shown in FIGS. 1-4, the handle portion 14 is an arcuate tubular structure which is adapted such that the ends of the handle portion 14 are integral with the rear surface 18 of the base portion 12. A user, such as a dentist, will grasp the handle portion 14 between the thumb a finger, or the thumb and a plurality of fingers. Although the handle portion 14 is shown as an arcuate tubular structure, it is understood that the handle portion 14 may be of any size and shape so as to be conveniently held by the user.

The dental tool 10 is fabricated of a material which can withstand conventional sterilization techniques, such as solid metal or the like. Particularly useful are alloys which will not rust easily during sterilization or use in the mouth. Alternatively, the dental tool 10 may be formed of any other suitable material including plastic and nylon, provided that the dental tool 10 is autoclavable.

Referring now to FIGS. 3 and 4, the dental tool 10 is shown in position for use according to the present invention in a method for re-sizing a tooth 50, such as in fixed restoration procedure. The hand of the user is not shown in FIGS. 3 and 4 in order to better illustrate use of the dental tool 10. In the position shown in the FIGs., the projection 22 is against the face of the tooth 50 being re-sized. Each side of the front surface 16 of the base portion 12 extends outwardly from the projection 22 and is positioned over the immediately adjacent teeth 52. To determine if a sufficient amount of material has been removed from the face of the tooth 50, the user moves the dental tool 10 relative to the teeth 50, 52 such that the projection 22 moves across the portion of the face of the tooth 50 to be removed. Preferably, the projection 22 extends from the front surface 16 of the base portion 14 a distance which is substantially equal to the amount of the face of the tooth 50 to be removed, usually about 1 millimeter to about 2.5 millimeters. If the appropriate amount of the face of the tooth 50 has been removed, the front surface 16 of the base portion will be in constant engagement with the faces of both of the adjacent teeth 52, in which case the re-sizing is complete. If a portion of the face of the tooth 50 has not been sufficiently removed, one side or the other of the front surface 16 of the base portion 14 will be caused to move out of engagement with the face of an adjacent tooth 52 as the projection passes over the “high spot”. The user then notes that additional tooth material must be removed from the area of the tooth 50 engaged by the projection 22.

The cross-sectional area of the projection 22 is preferably smaller than the tooth 50 undergoing re-sizing. This allows movement of the dental tool 10 and the projection 22 relative to the tooth 50. Moreover, the relative size of the planar portion of the front surface 16 of the base portion 12 is preferably large enough to be over both adjacent teeth 52 regardless of the position of the projection 22 on the tooth 50. Accordingly, it is understood that the projection 22 may be located anywhere on the front surface 16 of the base portion 12 as long as the position of the projection 22 allows the planar portion of the front surface 16 of the base portion 12 to remain over the two adjacent teeth 52.

Both FIGS. 3 and 4 also show a piece of carbon paper 48 between the dental tool 10 and the teeth 50, 52. Moving the dental tool 10 over the face of the tooth 50 and the carbon paper 48 will cause the projection 22 to mark the areas of the tooth 50 requiring further re-sizing with residue of the carbon paper 48. The user then has a visual indication on the tooth 50 of where to remove further tooth material after the dental tool 10 and carbon paper 48 are removed. The carbon paper 48 may be adhesively secured to the front surface 16 of the base portion 12 for this purpose. Alternatively, the base portion 12 and projection 22 could have the functionality of a writing instrument, such as a pencil, pen, marker and the like, wherein the projection 22 marks high spots on the face of the tooth 50 for subsequent removal.

It is understood that, although FIGS. 3 and 4 show the dental tool 10 according to the preset invention in use on the anterior, or front face, of a tooth 50, the present invention contemplates use of the dental tool 10 on the posterior, or back face, of the tooth 50.

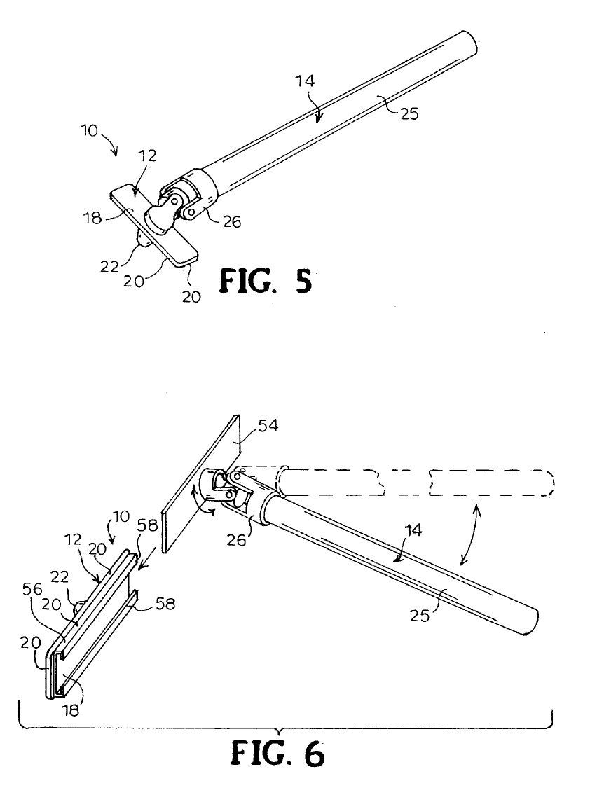

Another embodiment of a dental tool 10 according to the present invention is shown in FIG. 5. In this embodiment, the handle portion 14 comprises an elongated handle grip 25 and a joint 26 at one end of the handle grip. The joint 26 allows the base portion 12 to move relative to the handle portion 14. As shown, the joint 26 is a universal joint 26 which allows the base portion 12 to swivel and pivot relative to the handle portion 14 about an axis normal to the central axis of the base portion 12. This feature, along with the elongated handle grip 25 which may be grasped in the hand of the user, facilitates manipulation of the dental tool 10 and may provide easier access to all areas of the mouth including the back teeth. It is understood that the handle grip 25 could be rigidly attached to the rear surface 18 of the base portion 12 and still allow the user to realize some of these same advantages.

Yet another embodiment of a dental tool 10 according to the present invention is shown in FIG. 6. In this embodiment, a rectangular support plate 54 is fixed to the joint 26 at the one end of the handle grip 25. The rear surface 18 of the base portion 12 includes a flange 56 along each major edge 20, each flange 56 having an inwardly turned lip 58. The flanges 56 are spaced so that the support plate 54 at the end of the handle grip 25 is slidingly received between the flanges 56. The inwardly turned lips 58 on the flanges 56 hold the support plate 54 in place against the rear surface 18 of the base portion 12. This embodiment of the present invention allows the base portion 12 to be selectively removed and replaced. For example, the user may require projections 22 of various sizes. The base portion 12 could also be made to be disposable after a single use.

Although the present invention has been shown and described in considerable detail with respect to a few exemplary embodiments of the invention, it should be understood by those skilled in the art that it is not intended to limit the invention to specific embodiments disclosed. Various modifications, omissions, and additions may be made to the disclosed embodiments without materially departing from the novel teachings and advantages of the invention, particularly in light of the foregoing teachings. For example, it should be understood that any type of handle portion is suitable, such as a round handle portion. Accordingly, it is intended to cover all such modifications, omissions, additions, and equivalents as may be included within the spirit and scope of the invention as defined by the following claims. In the claims, means-plus-function clause(s) are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a crew may be equivalent structures.

What is claimed is:

1. A dental tool for use in determining an amount of material removed from a face of a tooth between two immediately adjacent teeth, the dental tool comprising:
a base member having a substantially planar surface; and
a projection extending from the planar surface a distance adapted to be equal to the amount of tooth material to be removed from the face of the tooth,
wherein the projection is adapted to be positioned adjacent any portion of the face of the tooth and the planar surface is sized such that the planar surface is over the two immediately adjacent teeth at all relative positions of the projection and the tooth.

2. A dental tool as recited in claim 1, wherein the distance is less than about 2 millimeters.

3. A dental tool as recited in claim 1, further comprising a handle member integral with the base member.

4. A dental tool as recited in claim 1, further comprising a handle member and means for connecting the handle member to the base member so that the base member is movable relative to the handle member.

5. A dental tool as recited in claim 4, wherein the connecting means is a universal joint.

6. A dental tool as recited in claim 1, further comprising a handle member and means for removably connecting the handle member to the base member.

7. A dental tool as recited in claim 1, wherein the base member and the projection comprise a marking instrument.

8. A method for determining an amount of material removed from a face of the tooth between two immediately adjacent teeth, the method comprising the steps of:
providing a dental tool comprising a base member having a substantially planar surface, and a projection extending from the planar surface a distance adapted to be equal to the amount of tooth material to be removed from the face of the tooth;
placing the dental tool against the tooth so that the projection is adjacent the face of the tooth and the planar surface is over the two immediately adjacent teeth; and
moving the dental tool relative to the teeth so that the projection engages all portions of the surface of the tooth to be removed and the planar surface is over the two immediately adjacent teeth at all relative positions of the projection and the tooth.

9. A method for determining an amount of material removed from a face of the tooth as recited in claim 8, further comprising the step of placing carbon between the projection and the face of the tooth.
